(19) United States
(12) Patent Application Publication
(10) Pub. No.: US 2004/0205197 A1
(43) Pub. Date: Oct. 14, 2004

(54) Automation system and system visualization method

(76) Inventor: Michael Schlereth, Wilhermsdorf (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/738,538

(22) Filed: Dec. 17, 2003

(30) Foreign Application Priority Data
Jul. 3, 2001 (DE) 10132038.8

(51) Int. Cl. G06F 15/16

(52) U.S. Cl. 709/228

(57) ABSTRACT

The invention relates to an automation system and a method for visualizing a system with a client (1) for displaying a web page consisting of data fields for displaying parameter values, comprising a processing unit (2) for storing actual parameter values. The modified parameter values can be interrogated by a client (1) by cyclical polling. Only the modified parameter values are transmitted to the client in an associated script and interpreted by the browser (3).

The invention relates to an automation system and a method for visualizing a system.

Methods of visualizing even real-time transactions over the Internet using traditional Internet browsers, in particular for financial data and stock market data, are known from the prior art. For this purpose a so-called “refresh” can be performed within predetermined time intervals; in other words, the whole web page presented on the client side is re-transmitted in its entirety from the server to the client.

Toward that end, the web page is constantly updated on the server side in order to enable cyclical page updating. A disadvantage with this approach is that for each update the entire web page—also including all graphics and the like—has to be transmitted, even if only one parameter or a small number of parameters is or are modified. Consequently a large amount of superfluous data is transmitted over the Internet, which is in any case limited in terms of its bandwidth.

A further approach known from the prior art is the use of a proprietary protocol with additional software on the client side. A disadvantage with this approach is that on the one hand the proprietary protocol is device- and/or vendor-dependent and so cannot be used for any and all systems. A further disadvantage is that proprietary protocols of this kind are not firewall-compatible.

Further previously known methods for updating web pages involve the use of applications called pushlets (http://www.fluidiom.com:8080) as well as the use of the media-streaming capabilities of the Hypertext Transfer Protocol (http).

The object of the invention is to create an improved automation system and an improved method for visualizing a system.

The object underlying the invention is achieved by the features of each of the independent claims. Preferred embodiments of the invention are specified in the dependent claims.

The invention permits the system controlled by an automation system and/or subsystems of such a system to be visualized by means of a so-called web browser on a client, for example an operator console. For the purpose of the data transfer in this case, documents written in a markup language, e.g. Hypertext Markup Language (html) or Extended Markup Language (XML), can be used.

The invention further permits the constant updating of parameter values of the visualized subsystem of the system which are displayed in the document on the browser. This can be accomplished efficiently and with only a small channel capacity requirement through the use of so-called script technology.

For example, a process called polling can be performed at certain predetermined time intervals, for example of one second or one minute, on the client side. This then leads to a processing unit being interrogated in order to determine only the modified parameter values. Only the modified parameter values are then transmitted to the client with a suitable script, with the result that the relevant parameter values in the document displayed by the browser are updated to the latest status. During this process the modified parameter values are assigned to display fields in the document on the basis of the scripts transferred along with the modified parameter values. These scripts are regenerated each time a value is modified on the server side, i.e. a value- and page-specific script is generated for each change in value.

Possible script languages suited to this purpose include, for example, JavaScript, Visual Basic, SVG, vrml, html, dhtml and XML.

The processing unit can be a so-called stored program control (SPC) which stores the latest parameter values and provides them with a timestamp.

The invention further permits good scalability of the automation system. In order to constantly update the system subsystem or the associated parameter values visualized by means of the browser it is not necessary to maintain a permanent connection between the client and the processing unit. Instead, for each polling operation such a connection is established only briefly, since the volume of data to be transmitted is limited to the modified parameter values, in other words only numeric values. Because of this further clients can easily be added to the automation system without this resulting in a bottleneck in terms of the channel capacity for the data transfer between the clients and the processing unit or the system server.

In addition the invention permits a so-called timeout to be efficiently determined. If the cyclical polling by the client does not take place, it can be concluded that the corresponding client process, in other words the visualization of the system subsystem concerned, has been aborted by the user of the client. Excessive timeouts of, say, twenty minutes—as is common practice in the prior art—can therefore be dispensed with.

A further advantage of the automation system according to the invention is that it can be made firewall-compatible, in particular if use is made of the so-called TCP/IP protocol, which is also employed on the Internet.

A further advantage of the invention is that commercially 1o available browser programs such as, for example, Netscape Navigator or Microsoft Internet Explorer can be used on the client side for displaying the documents in a markup language. The use of markup languages is similarly advantageous in order to visualize client-independent data in different types of representation.

The invention further permits redundancy to be implemented in an automation system in an efficient manner. If, for example, a server fails, its role can be taken over with ease by a redundant server without this necessitating a so-called reconnect—as is usually necessary with streaming solutions.

The invention is explained in more detail in the following on the basis of a preferred exemplary embodiment with reference to the drawings, in which:

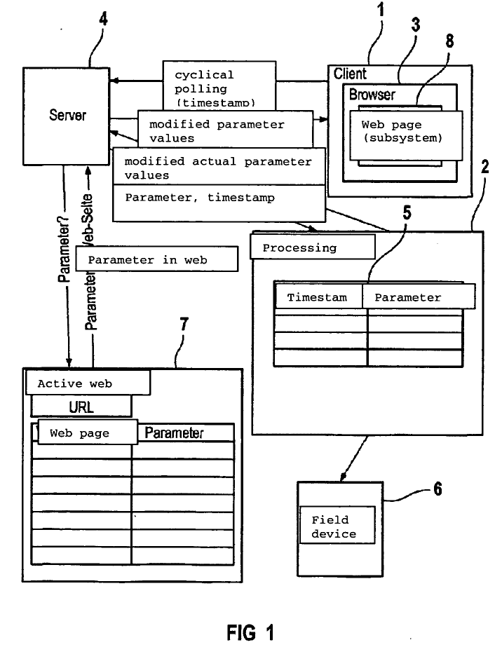

FIG. 1 shows a block diagram of an embodiment of an automation system according to the invention,

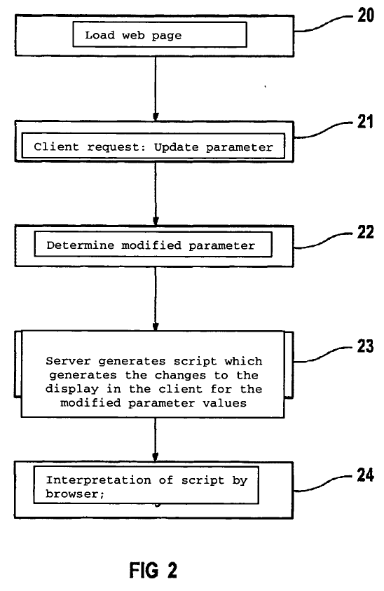

FIG. 2 shows a flow diagram for visualizing a system subsystem.

The automation system shown in FIG. 1 has a client 1 with a browser 3. The browser 3 can be a popular Internet browser, for example Netscape Navigator or Microsoft Internet Explorer. By entering a so-called Uniform Resource Locator (URL) a user can call up a specific web page 8. In this case the web page 8 can be used for visualizing a specific subsystem of the system controlled by the automation system.

Here, the web page 8 typically includes one or more display fields for displaying current parameter values such as, for example, pressures, temperatures, fill levels, and other sensor measurement values or machine parameters.

The client 1 is connected to a server 4. The TCP/IP protocol can be used as the protocol for the connection between client 1 and server 4. In this case it is possible to dispose an Internet-like computer network between the client 1 and the server 4.

The server 4 is connected to a storage 7 which contains the URL of the web page 8 currently displayed on the client 1. The server 4 therefore knows which web page is currently being visualized by each connected client.

The storage 7 further contains a table which includes the parameter names of the respective system subsystem which belong to each web page. By accessing the storage 7 the server 4 can therefore determine the parameter names displayed in the current web page of the client 1.

The server 4 is further connected to a processing unit 2. The processing unit 2 can be a so-called stored program control (SPC) to which one or more field devices 6 are connected. The processing unit 2 has a storage 5 for storing the latest parameter values with a corresponding timestamp. By this means the progression over time of the parameter values can be retrieved from the storage 5 by the processing unit 2. In the event of a lack of storage space on the processing unit 2 the modifications to the parameter values can also be buffered with timestamps in the server 4. The server 4 and the processing unit 2 can also be implemented together in a single device, i.e. an SPC directly supplies web pages with their values.

During the operation of the automation system shown in FIG. 1 the user of the client 1 initially enters the URL of the desired web page 8 into the browser 3. For this, the URL can be entered by selection of a so-called hyperlink, for example by clicking with a mouse. The web is preferably structured hierarchically for visualization of the system so that the user can select subsystems of the system by selection of corresponding hyperlinks on a start page. The URL of the desired web page 8 is stored in each of the hyperlinks.

The web page 8 is transmitted to the client 1 by the server 4 and visualized by the browser 3. The URL of the web page 8 is stored by the server 4 in the storage 7. The server determines the parameters associated with the web page 8 from the table stored in the storage 7 and polls the current parameter values by interrogating the processing unit 2. The latter transmits the current parameter values to the server 4, which transfers these to the client 1 as part of the web page 8.

Subsequently the client 1 uses cyclical polling to interrogate the server 4 for updates to the parameter values. With an updating request of this kind from the client 1 to the server 3, a timestamp relating to the last update of the parameter values is also transmitted. The server 4 then determines from the storage 7 in turn the parameters of the web page 8 and interrogates the processing unit 2 for those parameter values which have been modified since the last update, in other words such parameter values having a timestamp greater than the timestamp transmitted by the client 1 to the server 4.

These updated parameter values are then transmitted by the processing unit 2 to the server 4. The server 4 generates a script which can enter all the modified parameter values in a data field assigned to the corresponding parameter on the web page 8 or visualize the parameter graphically or textually. The parameter names are assigned to the data fields or other graphical or textual representations in the web page 8 in accordance with the table contained in the storage 7.

If, for example, a bar for a fill level is displayed on the web page, then instead of, for example, the fill level in meters being transmitted, a script is transmitted which generates a rectangle with, for example, a width of 1 cm and a height of 10 cm (according to the fill level).

The script containing the changes in the representation is then transmitted to the client 1 and interpreted by the browser 3 so that the corresponding display elements of the web page 8 can be updated with the modified parameter values. This operation can be repeated cyclically at specified time intervals, whereby the cycle time can be selected according to the time dynamics of the system process to be visualized.

FIG. 2 shows a flow diagram designed to illustrate an embodiment of the system visualization according to the invention. First, in step 20, the web page of the desired system subsystem is loaded with the current parameter values. In the process the URL of the web page concerned is stored on the server side.

In step 21 the updating of the parameter values of the web page is requested by the client at a later time.

In step 22 the server then determines the parameters belonging to the web page. The server then receives the parameter values modified since the last update from the storage of the processing unit.

In step 23 the server then generates a script which can generate the changes to the display in the client for the modified parameter values.

In step 24 this data is then interpreted by the browser of the client and the web page is updated accordingly.

1. An automation system for use with a client for displaying a web page, the web page having fields for displaying parameter values, comprising
a processing unit with a storage for storing current parameter values;
means for cyclical polling of modified parameter values from the processing unit; and
means for transmitting the modified parameter values with a script for assigning the modified parameter values to display modifications and/or display elements of the web page.

2. An automation system according to claim 1, wherein the web page is displayed by a browser.

3. An automation system according to claim 1, wherein the client is a monitoring unit or operator console.

4. An automation system according to claim 1, wherein the processing unit is a stored program control to which at least one field devices are connected.

5. An automation system according to claim 1, wherein the processing unit is configured for storing the current parameter values together with a corresponding timestamp.

6. An automation system according to claim 1 wherein a server is connected to the client and the processing unit.

7. An automation system according to claim 1 further comprising a second storage (7) for storing a representation of the web page.

8. An automation system according to claim 7, wherein the processing unit, the means for transmitting the modified values and/or the second storage form a single structural entity.

9. An automation system according to claim 1, wherein a web is stored on the server and one or more pages of the web are assigned to one or more subsystems of the system controlled by the automation system.

10. An automation system according to claim 1, wherein the means for cyclical polling of the modified parameter values are configured for polling at intervals of two minutes and the connection between the client and the server is interrupted after each completed poll.

11. A method for visualizing a system comprising the following steps:
displaying a web page representing a subsystem of the system with parameter values;
cyclically polling a processing unit for modified parameter values; and
transmiting the modified parameter values with a script for assigning the modified value to a corresponding display element of the web page.

12. A method according to claim 11, wherein the web page is a document created using a markup language.

13. A method according to claim 11, wherein a TCP/IP protocol is used for transmitting the modified parameter value.

14. A method according to claim 11, further comprising the following steps:
storing a representation of the web page,
determining the parameters belonging to the web page from the representation of the web page,
polling the processing unit for the current parameter values of the parameters determined from the representation of the web page.

15. A method according to claims 11, wherein the parameter values are stored in the processing unit together with a timestamp.

16. A computer program product arranged on a computer-readable medium, comprising:
a computer program adapted to display a web page representing a subsystem of the system with parameter values, cyclically poll a processing unit for modified parameter values, and transmit the modified parameter values with a script for assigning the modified value to a corresponding display element of the web page.
an automation system on which the computer program product is run.

17. An automation system for use with a client for displaying a web page, wherein the web page having fields for displaying parameter values, comprising
a processing unit with a storage for storing current parameter values;
a browser adapted to cyclically poll modified parameter values from the processing unit; and
a server adapted to transmit the modified parameter values with a script for assigning the modified parameter values to display modifications or elements of the web page.

18. An automation system according to claim 17, wherein a web is stored on the server and one or more pages of the web are assigned to one or more subsystems of the system controlled by the automation system.

19. An automation system according to claim 17, wherein the cyclical polling of the modified parameter values are configured for polling at intervals of two minutes and the connection between the client and the server is interrupted after each completed poll.
